(19) United States
(12) Patent Application Publication
(10) Pub. No.: US 2026/0213647 A1
(43) Pub. Date: Jul. 23, 2026

(54) POWER SUPPLY DEVICE AND IMAGE PROCESSING APPARATUS

(71) Applicant: Konica Minolta, Inc., Tokyo (JP)

(72) Inventors: Yukinobu IGUCHI, Hamamatsu-shi (JP); Takeshi TAMADA, Toyohashi-shi (JP); Natsuyo IDA, Toyokawa-shi (JP); Takashi WATANABE, Toyokawa-shi (JP); Hirotada SEKI, Toyokawa-shi (JP); Genta SASAKI, Toyokawa-shi (JP)

(73) Assignee: Konica Minolta, Inc., Tokyo (JP)

(21) Appl. No.: 19/448,780

(22) Filed: Jan. 14, 2026

(30) Foreign Application Priority Data
Jan. 17, 2025 (JP) 2025-006697

(51) Int. Cl. H02M 1/42; G03G 15/00

(52) U.S. Cl. CPC H02M 1/4208; G03G 15/5004; G03G 15/55; G03G 15/80

(57) ABSTRACT

A power supply device includes an AC input section to which any one of a plurality of commercial power supplies is connectable, a power storage, a power factor correction circuit that converts AC that is input to the AC input section into DC of a predetermined voltage, and outputs the DC to the power storage and an external first and an external second load that are connected in parallel, and a switch section that, during an instantaneous power failure of the commercial power supply connected to the AC input section, switches the power supply device to a state where power is supplied from the power storage to the first load and power is not supplied from the power storage to the second load.

### CROSS-REFERENCE TO RELATED APPLICATIONS

The entire disclosure of Japanese patent Application No. 2025-6697 filed on January 17, 2025, is incorporated herein by reference in its entirety.

### BACKGROUND OF THE INVENTION

### Technical Field

The present invention relates to a power supply device and an image forming apparatus. In particular, the present invention relates to a power supply device connected to any one of a plurality of types of commercial power supplies, and an image forming apparatus including the power supply device.

### DESCRIPTION OF RELATED ART

The image forming apparatus includes a power supply device connected to a commercial power supply. This power supply device may be connectable to any one of a plurality of types of commercial power supplies. The plurality of types of commercial power supplies have different voltages or different frequencies. On the other hand, an instantaneous power failure may occur in a commercial power supply. The power supply device includes a power storage such as a capacitor in order to cope with an instantaneous power failure.

For example, Japanese Unexamined Patent Publication No. 2015-138112 describes a power supply device that connects a first power supply and a second power supply in parallel and supplies power that is supplied from the first power supply and power that is supplied from the second power supply to a load, with the first power supply using power supplied from outside as an input source and having a constant-voltage output, and with the second power supply using output of a storage battery as an input source, includes a constant-voltage load power supplier that supplies power to a constant-voltage load, a heater power supplier that supplies power to a heater, a DC inner bus that connects the first power supply, the second power supply, the constant-voltage load power supplier and the heater power supplier, a load power detector that detects load power of the DC inner bus, a power supply controller that controls an output of the second power supply, and an input power detector that detects input power that is input to the first power supply from outside, wherein the power supply controller controls an output of the second power supply such that input power detected by the input power detector is equal to the first threshold value.

However, in a case in which power received from outside is instantaneously cut off, power is supplied only from the second power supply to a constant voltage load power supplier and a heater power supplier. Therefore, the capacitance of a storage battery must be increased. Therefore, there is a problem that the product cost is increased.

### SUMMARY OF THE INVENTION

A power supply device according to one aspect of the present invention includes an AC input section to which any one of a plurality of commercial power supplies is connectable, a power storage, a power factor correction circuit that converts AC that is input to the AC input section into DC of a predetermined voltage, and outputs the DC to the power storage and an external first and an external second load that are connected in parallel, and a switch section that, during an instantaneous power failure of the commercial power supply connected to the AC input section, switches the power supply device to a state where power is supplied from the power storage to the first load and power is not supplied from the power storage to the second load.

An image processing apparatus according to another aspect of the present invention includes the power supply device, the first load and the second load, described above

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a cross-sectional view schematically illustrating one example of the inner configuration of an MFP according to one embodiment of the present invention;

FIG. 2 is a block diagram illustrating the outline of the hardware configuration of the MFP in the present embodiment;

FIG. 3 is a diagram illustrating one example of the configuration of an internal circuit of a power supply device in the present embodiment;

FIG. 4 is a diagram illustrating one example of a voltage in a circuit during an instantaneous power failure of the power supply device in the present embodiment;

FIG. 5 is a diagram illustrating one example of a voltage in a circuit of a comparative example;

FIG. 6 is a diagram illustrating one example of the configuration of an internal circuit of a power supply device in a first modification example;

FIG. 7 is a diagram illustrating one example of a voltage in a circuit during an instantaneous power failure of the power supply device in the first modification example;

FIG. 8 is a diagram illustrating one example of the configuration of an internal circuit of a power supply device in a second modification example; and

FIG. 9 is a diagram illustrating one example of a voltage in a circuit during an instantaneous power failure of the power supply device in the second modification example.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. In the following description, the same components are denoted by the same reference numerals. Their names and functions are also the same. Therefore, a detailed description thereof will not be repeated.

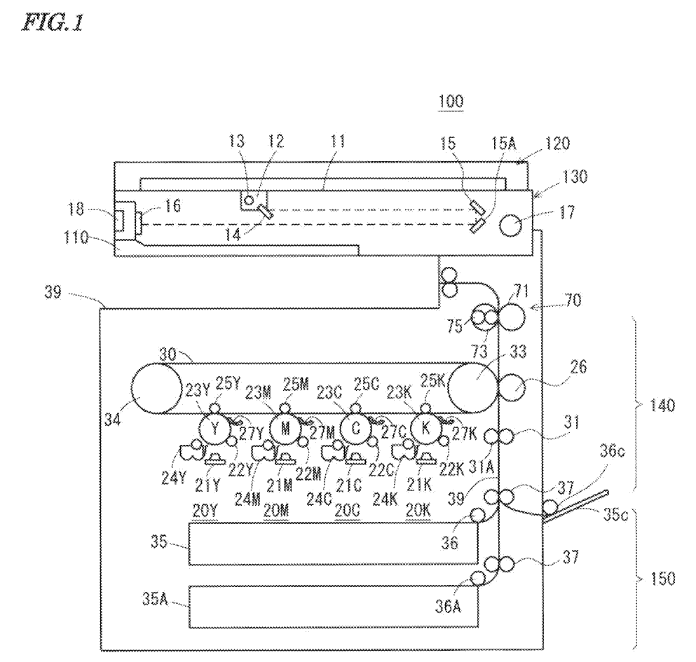

FIG. 1 is a cross-sectional view schematically illustrating one example of the inner configuration of an MFP in the present embodiment. The Multi Function Peripheral (MFP) 100 is one example of an image processing apparatus. With reference to FIG. 1, the MFP 100 includes an automatic document conveyance device 120, a document reading section 130 that reads a document, an image forming section 140 that forms an image on a sheet based on image data, and a sheet feed section 150 that feeds a sheet to the image forming section 140.

The automatic document conveyance device 120 automatically conveys a plurality of documents set on a document tray to a predetermined document reading position set on a platen glass of the document reading section 130 one by one. The automatic document conveyance device 120 discharges a document having an image formed thereon by the document reading section 130 onto a document ejection tray.

The document reading section 130 exposes an image of a document set on a document glass 11 with an exposure lamp 13 attached to a slider 12 moving below the document glass 11. The light reflected from the document is guided to a lens 16 by a mirror 14 and two reflecting mirrors 15, 15A, and forms an image on a Charge Coupled Device (CCD) sensor 18.

The reflected light that has formed an image on the CCD sensor 18 is converted into image data as an electric signal in the CCD sensor 18. The image data is converted into printing data pieces of cyan (C), magenta (M), yellow (Y) and black (K), and output to the image forming section 140.

The image forming section 140 includes respective image forming units 20Y, 20M, 20C, 20K for respective yellow, magenta, cyan and black. Here, “Y,” “M,” “C” and “K” represent yellow, magenta, cyan and black, respectively. An image is formed by driving of at least one of the image forming units 20Y, 20M, 20C, 20K. When all of the image forming units 20Y, 20M, 20C, 20K are driven, a full-color image is formed. Printing data pieces for yellow, magenta, cyan and black are respectively input to the image forming units 20Y, 20M, 20C, 20K. The only difference among the image forming units 20Y, 20M, 20C, 20K is the colors of toners used by the image forming units 20Y, 20M, 20C, 20K. Therefore, the image forming unit 20Y for forming an image in yellow will be described here.

The image forming unit 20Y includes an exposure device 21Y, a photosensitive drum 23Y, a charging roller 22Y, a developing device 24Y and a primary transfer roller 25Y. Around the photosensitive drum 23Y, the charging roller 22Y, the exposure device 21Y, the developing device 24Y, the primary transfer roller 25Y and a drum cleaning blade 27Y are arranged in this order in a rotation direction of the photosensitive drum 23Y. The yellow printing data piece is input to the exposure device 21Y. The photosensitive drum 23Y is an image bearing member. The charging roller 22Y uniformly charges the surface of the photosensitive drum 23Y. The primary transfer roller 25Y transfers a toner image formed on the photosensitive drum 23Y onto an intermediate transfer belt 30, serving as an image bearing member, using the effect of an electric field force.

After being electrically charged by the charging roller 22Y, the photosensitive drum 23Y is irradiated with laser light emitted by the exposure device 21Y. The exposure device 21Y exposes a portion corresponding to the image on the surface of the photosensitive drum 23Y. Thus, an electrostatic latent image is formed on the photosensitive drum 23Y. Subsequently, the developing device 24Y develops the electrostatic latent image formed on the photosensitive drum 23Y with the charged toner. Specifically, toner is placed on the electrostatic latent image formed on the photosensitive drum 23Y due to the effect of an electric field force, so that the toner image is formed on the photosensitive drum 23Y. The toner image formed on the photosensitive drum 23Y is transferred onto the intermediate transfer belt 30 serving as an image bearing member by the primary transfer roller 25Y with use of the effect of an electric field force. The toner remaining on the photosensitive drum 23Y without being transferred is removed from the photosensitive drum 23Y by the drum cleaning blade 27Y.

The intermediate transfer belt 30 is suspended by a driving roller 33 and a driven roller 34 so as not to loosen. When the driving roller 33 is rotated in a counterclockwise direction in the diagram, the intermediate transfer belt 30 is rotated in the counterclockwise direction in the diagram at a predetermined speed. The driven roller 34 is rotated in the counterclockwise direction in accordance with the rotation of the intermediate transfer belt 30.

Thus, the image forming units 20Y, 20M, 20C, 20K sequentially transfer toner images onto the intermediate transfer belt 30. Timing for transferring toner images onto the intermediate transfer belt 30 by the respective image forming units 20Y, 20M, 20C, 20K is adjusted based on detection of a reference mark provided on the intermediate transfer belt 30. Thus, toner images in yellow, magenta, cyan and black are superimposed on the intermediate transfer belt 30.

In sheet feed cassettes 35, 35A, sheets in different sizes are respectively set. The sheets respectively stored in the sheet feed cassettes 35, 35A are supplied to a conveyance path by pickup rollers 36, 36A respectively attached to the sheet feed cassettes 35, 35A and are sent to a timing roller 31 by a sheet feed roller 37.

A sheet conveyed by the timing roller 31 is conveyed to a nip portion in which the intermediate transfer belt 30 and a secondary transfer belt 26 come into contact with each other. A toner image formed on the intermediate transfer belt 30 is transferred onto a sheet with the effect of an electric field force by the secondary transfer belt 26 serving as a transfer member. The sheet to which the toner image is transferred is conveyed to a fixing device 70.

The fixing device 70 includes a pressing roller 71 and a heating roller 73. The heating roller 73 is a member having a hollow cylindrical shape, and the rotation shaft of the heating roller 73 is supported by a main body case. The heating roller 73 includes a built-in DC fixing lamp 75. The inner diameter of the heating roller 73 is set such that the DC fixing lamp 75 does not come into contact with the heating roller 73. The heating roller 73 is made of stainless steel. The heating roller 73 may be made of aluminum.

The DC fixing lamp 75 is a halogen heater, for example. In the present embodiment, two halogen heaters having different emission lengths are used as a heat source 54. Note that the DC fixing lamp 75 is not limited to a halogen heater, and a resistive light emitter or Induction Heating (IH) may be used.

When the DC fixing lamp 75 generates heat, the heating roller 73 is heated, and the temperature of the heating roller 73 rises. A thermistor (not illustrated) is arranged at a predetermined distance from the heating roller 73. The temperature of the heating roller 73 is detected by the thermistor. In accordance with the temperature detected by the thermistor, the DC fixing lamp 75 is controlled to be turned ON or OFF, and the heating roller 73 is controlled to have a predetermined temperature.

The pressing roller 71 has a cylindrical shape and is arranged opposite to the heating roller 73. The pressing roller 71 is biased toward the heating roller 73. Therefore, in a period during which a sheet to which a toner image is transferred passes between the pressing roller 71 and the heating roller 73, the sheet is heated and pressurized by the pressing roller 71 and the heating roller 73. Thus, toner is fused and fixed to the sheet. Thereafter, the sheet is conveyed to a sheet ejection tray 39.

While driving all of the image forming units 20Y, 20M, 20C, 20K in a case in which forming a full-color image, the MFP 100 drives any one of the image forming units 20Y, 20M, 20C, 20K in a case in which forming a monochrome image. It is also possible to form an image by combining two or more of the image forming units 20Y, 20M, 20C, 20K. Here, the MFP 100 uses a tandem-system including the image forming units 20Y, 20M, 20C, 20K that respectively form toner images in four colors on a sheet, by way of example. However, the MFP 100 may use a four-cycle system that sequentially transfers the toner images in four colors onto a sheet using one photosensitive drum.

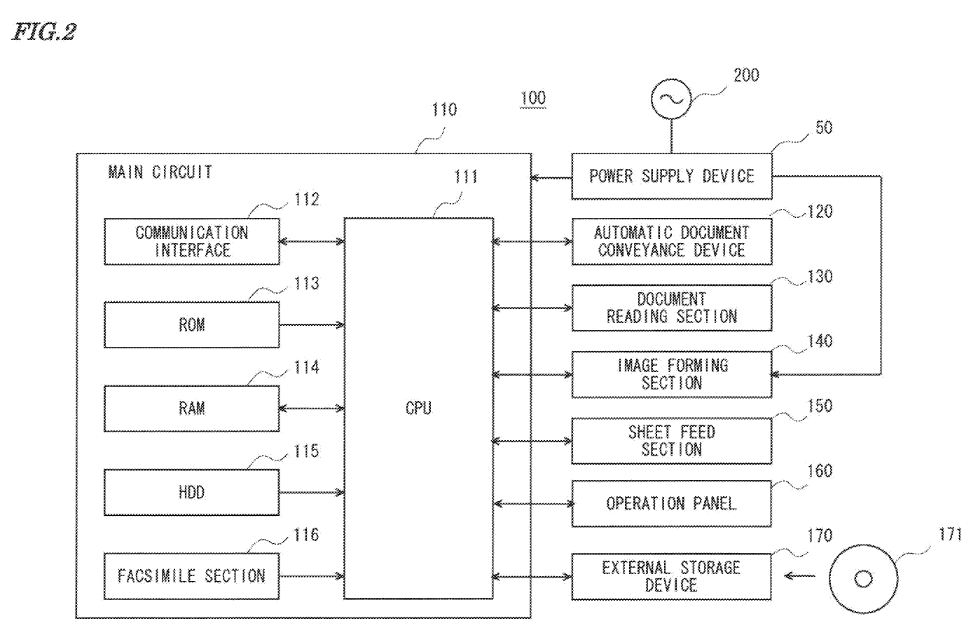

FIG. 2 is a block diagram illustrating the outline of the hardware configuration of the MFP in the present embodiment. With reference to FIG. 2, the MFP 100 includes a main circuit 110, a power supply device 50, the automatic document conveyance device 120, the image forming section 140, the sheet feed section 150, an operation panel 160 and an external storage device 170. The operation panel 160 is a user interface.

The power supply device 50 is connected to a commercial power supply 200, and converts AC (alternating current) to DC (direct current) of a predetermined voltage. The power supply device 50 supplies the DC of the predetermined voltage to the main circuit 110 and the DC fixing lamp 75 of the image forming section 140. Although not illustrated, the power supply device 50 may supply AC or DC supplied from the commercial power supply 200 to the automatic document conveyance device 120, the document reading section 130, the image forming section 140, the sheet feed section 150, the operation panel 160 and the external storage device 170.

The main circuit 110 includes a CPU 111, a communication interface (I/F) 112, a ROM 113, a RAM 114, an HDD 115 and a facsimile section 116.

The ROM 113 stores a program to be executed by the CPU 111 or that is required for execution of the program. The RAM 114 is a nonvolatile memory. The RAM 114 is used as a work area when the CPU 111 executes a program. Further, the RAM 114 temporarily stores read images successively sent from the document reading section 130.

The communication interface 112 is an interface for connecting the MFP 100 to a network. The communication interface 112 communicates with a computer connected to a network using a communication protocol such as Transmission Control Protocol (TCP) or File Transfer Protocol (FTP).

The HDD 115 is a mass storage device. Instead of the HDD 115, a Solid State Drive (SSD) may be used. The CPU 111 is connected to the automatic document conveyance device 120, the document reading section 130, the image forming section 140, the sheet feed section 150 and the operation panel 160, and controls the MFP 100 as a whole.

The facsimile section 116 is connected to a Public Switched Telephone Network (PSTN) and transmits facsimile data to the PSTN, and the facsimile section 116 receives facsimile data from the PSTN. The facsimile section 116 converts the received facsimile data into printing data that is printable in the image forming section 140 and outputs the printing data to the image forming section 140. Thus, the image forming section 140 forms, on a sheet, an image represented by the facsimile data received from the facsimile section 116. The facsimile section 116 may store the received facsimile data in the HDD 115. Further, the facsimile section 116 converts the data stored in the HDD 115 into facsimile data and transmits the converted facsimile data to a facsimile machine connected to the PSTN.

The operation panel 160 is provided on an upper surface of the MFP 100. The operation panel 160 includes a display part and an operation part. The display part is a Liquid Crystal Display (LCD), for example, and displays an instruction menu for a user, information about acquired image data and the like. As long as displaying images, an organic EL display may be used instead of an LCD, for example. The operation part 163 includes a touch screen and a plurality of hard keys. The hard keys are contact switches, for example.

The external storage device 170 is controlled by the CPU 111 and is mounted with a CD-ROM 171. In the present embodiment, the CPU 111 executes a program stored in the ROM 113, by way of example. The CPU 111 may control the external storage device 170 to read a program to be executed by the CPU 111 from the CD-ROM 171 and store the read program in the RAM 114 for execution.

A recording medium for storing a program to be executed by the CPU 111 is not limited to the CD-ROM 171 but may be a medium such as a flexible disc, a cassette tape, an optical disc or a semiconductor memory. The optical disc includes Magnetic Optical Disc (MO)/MiniDisc(MD)/Digital Versatile Disc(DVD). The semi-conductor memory includes an IC card, an optical card, a mask ROM or an Erasable Programmable ROM (EPROM).

Further, the CPU 111 may load a program stored in the HDD 115 into the RAM 114 for execution in the CPU 111. The program stored in the HDD 115 includes a program downloaded by the CPU 111 from a computer connected to the Internet, or a program written in the HDD 115 by a computer connected to the Internet. The program referred to here includes not only a program directly executable by the CPU 111 but also a source program, a compressed program, an encrypted program or the like.

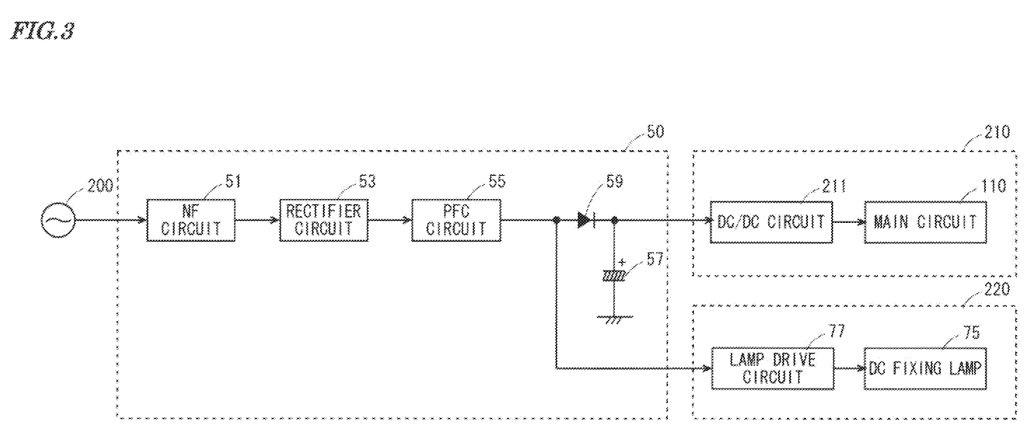

FIG. 3 is a diagram illustrating one example of the configuration of an internal circuit of the power supply device according to the present embodiment. With reference to FIG. 3, the power supply device 50 includes an NF circuit 51, a rectifier circuit 53, a PFC circuit 55, a diode 59 and a capacitor 57, with the NF circuit 51 being connected to the commercial power supply 200. The NF circuit 51 is compatible with a plurality of types of commercial power supplies. There are a plurality of types of commercial power supplies having different voltages, different frequencies, etc. The NF circuit 51 is connected to any one of the plurality of types of commercial power supplies. Here, the NF circuit 51 is connected to one commercial power supply 200 among the plurality of types of commercial power supplies, by way of example.

The NF circuit 51 is a noise filter that removes harmonic noise from AC supplied from the commercial power supply 200. The rectifier circuit 53 is connected to the NF circuit 51 and receives an output of the NF circuit 51.

The rectifier circuit 53 rectifies the output of the NF circuit 51 and converts the output into a DC voltage. The rectifier circuit 53 includes a full-wave rectifier circuit using a diode, and a smoothing circuit provided downstream of the full-wave rectifier circuit. The smoothing circuit smooths pulsating current into DC.

The Power Factor Collect (PFC) circuit 55 receives an output of the rectifier circuit 53. The PFC circuit 55 receives the output of the rectifier circuit 53, generates DC of a predetermined voltage, and improves a power factor.

An output of the PFC circuit 55 is connected to an anode of the diode 59. A cathode of the diode 59 is connected to a first load 210. A second load 220 is connected between the PFC circuit 55 and the anode of the diode 59. One end of the capacitor 57 is connected between the cathode of the diode 59 and the first load 210. The other end of the capacitor 57 is grounded. The capacitor 57, the first load 210 and the second load 220 are connected in parallel to the PFC circuit 55.

The first load 210 includes a DC/DC circuit 211 and the main circuit 110.

The DC/DC circuit 211 transforms a DC voltage received from the PFC circuit 55. The DC/DC circuit 211 converts the DC voltage received from the PFC circuit 55 into a voltage defined in accordance with the main circuit 110.

The second load 220 includes a lamp drive circuit 77 and the DC fixing lamp 75. The lamp drive circuit 77 receives a temperature detected by the thermistor arranged at a predetermined distance from the heating roller 73. The lamp drive circuit 77 controls ON and OFF of the DC fixing lamp 75 in accordance with the temperature detected by the thermistor.

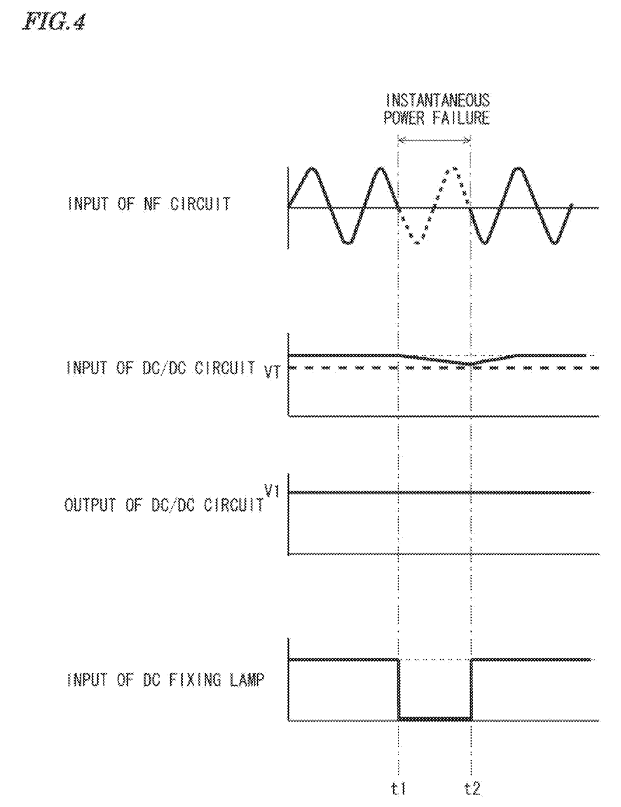

FIG. 4 illustrates diagrams illustrating one example of a voltage in a circuit during an instantaneous power failure of the power supply device in the present embodiment. FIG. 4 illustrates, in order from the top, an input voltage of the NF circuit 51, an input voltage of the DC/DC circuit 211, an output voltage of the DC/DC circuit 211 and an input voltage of the DC fixing lamp 75. Note that the input voltage of the DC fixing lamp 75 is a voltage in a case in which the DC fixing lamp 75 is switched ON by the lamp drive circuit 77.

It illustrates an instantaneous power failure in which power is not instantaneously supplied to the commercial power supply 200 for 20 ms from a point t1 to a point t2 in time. During the instantaneous power failure, power is not supplied to the input voltage of the NF circuit 51 from the commercial power supply 200.

With reference to FIG. 3, with the NF circuit 51 not receiving AC from the commercial power supply 200, an output voltage of the PFC circuit 55 drops. Thus, the capacitor 57 starts discharging, and a DC voltage is applied to the DC/DC circuit 211. Therefore, as illustrated in the second diagram from the top in FIG. 4, although gradually dropping, an input voltage of the DC/DC circuit 211 is maintained equal to or larger than a lower limit value VT1. The output voltage of the DC/DC circuit 211 is maintained at a constant value V1 also during the instantaneous power failure. Because being interrupted by the diode 59, power supplied from the capacitor 57 is not supplied to the lamp drive circuit 77. Therefore, the capacitance of the capacitor 57 is defined based on the power consumption of the main circuit 110 of the first load 210, and a power failure period of time, with the power failure period of time being predetermined as the maximum period of time during which power is instantaneously not supplied to the commercial power supply 200. In other words, the capacitance of the capacitor 57 does not need to be defined in consideration of the power consumption of the second load 220.

The input voltage of the DC fixing lamp 75 drops to zero at the point t1 in time, and becomes a voltage that is output from the PFC circuit 55 at the point t2 in time.

The lamp drive circuit 77 is a relay circuit for switching ON and OFF of a switch of the DC fixing lamp 75 based on an output of a thyristor, and does not include a nonvolatile memory or a CPU. Therefore, even after a voltage supplied to the lamp drive circuit 77 drops to zero, the ON-OFF control for the DC fixing lamp 75 can be continued after the supply of a voltage is restarted.

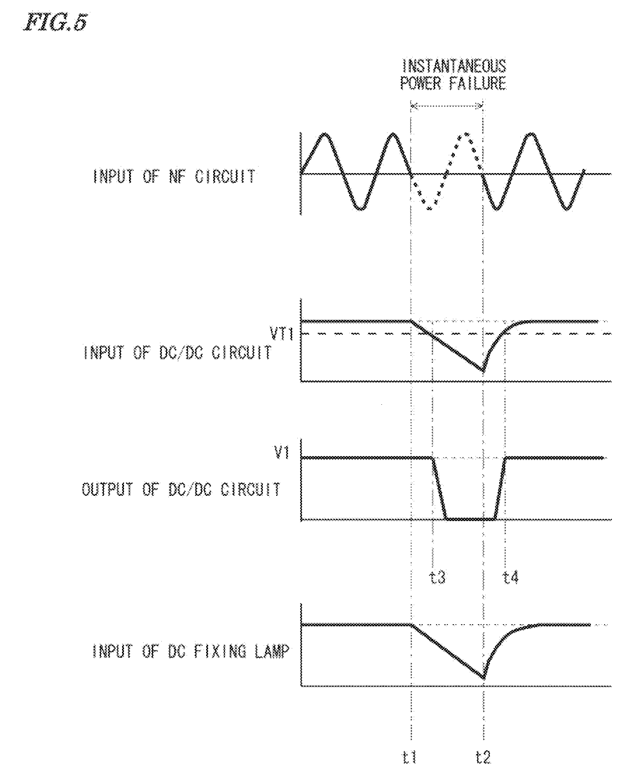

Here, a circuit of a comparative example in which the diode 59 is removed from the internal circuit of the power supply device 50 illustrated in FIG. 3 will be described. FIG. 5 is a diagram illustrating one example of a voltage in the circuit of the comparative example. FIG. 5 illustrates, in order from the top, an input voltage of an NF circuit 51, an input voltage of a DC/DC circuit 211, an output voltage of a DC/DC circuit 211 and an input voltage of a DC fixing lamp 75. Note that the input voltage of the DC fixing lamp 75 is a voltage in a case in which the DC fixing lamp 75 is switched ON by the lamp drive circuit 77.

It illustrates an instantaneous power failure in which power is not instantaneously supplied to a commercial power supply 200 for 20 ms from a point t1 to a point t2 in time. During the instantaneous power failure, power is not supplied to the input voltage of the NF circuit 51 from the commercial power supply 200.

With the NF circuit 51 not receiving AC from the commercial power supply 200, an output voltage of a PFC circuit 55 drops. Thus, a capacitor 57 starts discharging, and a DC voltage is applied to the DC/DC circuit 211 and the lamp drive circuit 77. Therefore, as illustrated in the fourth diagram from the top in FIG. 5, the input voltage of the DC fixing lamp 75 gradually drops from the point t1 in time and reaches the lowest value at the point t2 in time. After the point t2 in time, the input voltage of the DC fixing lamp 75 gradually increases and becomes a voltage that is output from the PFC circuit 55. The reason why the input voltage of the DC fixing lamp 75 does not immediately become the voltage that is output from the PFC circuit 55 at the point t2 in time is because the capacitor 57 stores electric charge.

On the other hand, as illustrated in the second diagram from the top in FIG. 5, the input voltage of the DC/DC circuit 211 gradually drops and falls below a lower limit value VT1 at a point t3 in time. Although power supplied from the capacitor 57 is supplied to the DC/DC circuit 211, the voltage falls below the lower limit value VT1 because the power is consumed by the lamp drive circuit 77. Although the supply of a constant voltage from the PFC circuit 55 is restarted at the point t2 in time, because the capacitor 57 starts to store electric charge, the voltage gradually increases and reaches the lower limit value VT1 at a point t4 in time.

The input voltage of the DC/DC circuit 211 gradually drops from the point t3 in time to reach zero, and gradually increases from the point t2 in time to reach, at the point t4 in time, a voltage V1 at which the main circuit 110 can be driven. Therefore, the voltage V1 at which the main circuit 110 can be driven is not supplied to the main circuit 102 at the point t3 in time.

At the point t3 in time, data stored in the RAM 114 is deleted, and the CPU 111 stops working. Thereafter, at the point t4 in time, the CPU 111 is restarted. For this reason, when an instantaneous power failure occurs, the CPU 111 is restarted. Therefore, it is no longer possible to continue the work before the instantaneous power failure.

### First Modification Example

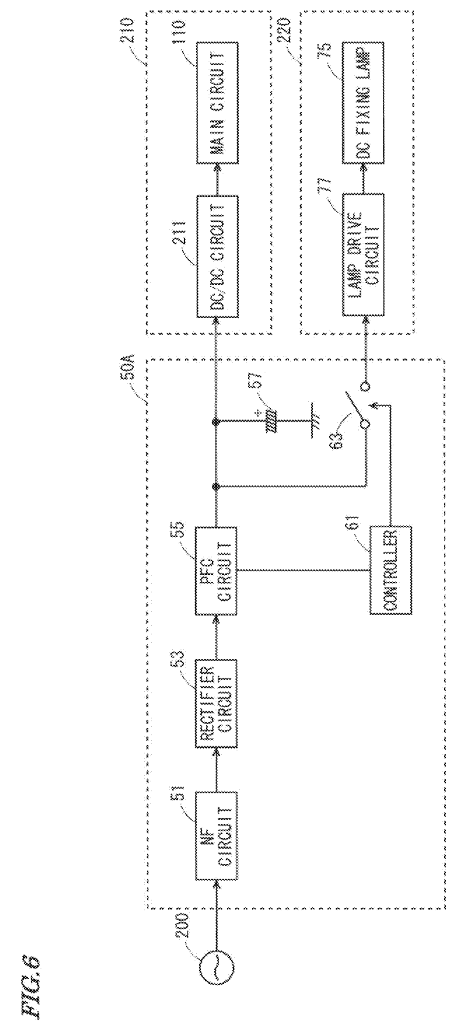

FIG. 6 is a diagram illustrating one example of the configuration of an internal circuit of a power supply device according to a first modification example. With reference to FIG. 6 the power supply device 50A in the first modification example is different from the above-mentioned power supply device 50 in that the diode 59 is not present, a switch 63 is arranged between a PFC circuit 55 and a second load 220, and a controller 61 is added. The other configurations of the power supply device 50A in the first modification example are the same as those of the above-mentioned power supply device 50. Therefore, the detailed description thereof will not be repeated.

The power supply device 50A according to the first modification example includes an NF circuit 51, a rectifier circuit 53, the PFC circuit 55, a capacitor 57, the switch 63 and the controller 61.

An output of the PFC circuit 55 is connected to one end of the capacitor 57, a first load 210 and one end of the switch 63. The other end of the capacitor 57 is grounded. The other end of the switch 63 is connected to a second load 220. The capacitor 57, the first load 210 and the second load 220 are connected in parallel to the PFC circuit 55. The one end of the switch 63 is connected between the PFC circuit 55 and the one end of the capacitor 57. Note that the one end of the switch 63 may be connected between the one end of the capacitor 57 and the first load 210.

The controller 61 is a microcomputer, and includes a CPU, a ROM and a RAM. The controller 61 is driven by receiving power supplied from the PFC circuit 55. The controller 61 may include a capacitor as a backup power supply. Further, the controller 61 may be built in the PFC circuit 55.

The controller 61 receives an output voltage of the PFC circuit 55. The PFC circuit 55 includes a detector that detects an output voltage, and outputs a value of the output voltage detected by the detector. The controller 61 controls the switch 63 based on the output voltage of the PFC circuit 55. The controller 61 compares the value of the output voltage of the PFC circuit 55 with a predetermined threshold value VT2. The controller 61 closes the switch 63 in a period during which the value of the output voltage of the PFC circuit 55 is larger than the threshold value VT2, and opens the switch 63 in a period during which the value of the output voltage of the PFC circuit 55 is equal to or smaller than the threshold value VT2. Therefore, in a period during which the value of the output voltage of the PFC circuit 55 is larger than the threshold value VT2, power is supplied to the second load 220. In a period during which the value of the output voltage of the PFC circuit 55 is equal to or smaller than the threshold value VT2, power is not supplied to the second load 220. The threshold value VT2 is defined based on the maximum power consumption of the first load 210. Preferably, the threshold value VT2 is equal to or larger than the maximum power consumption of the first load 210.

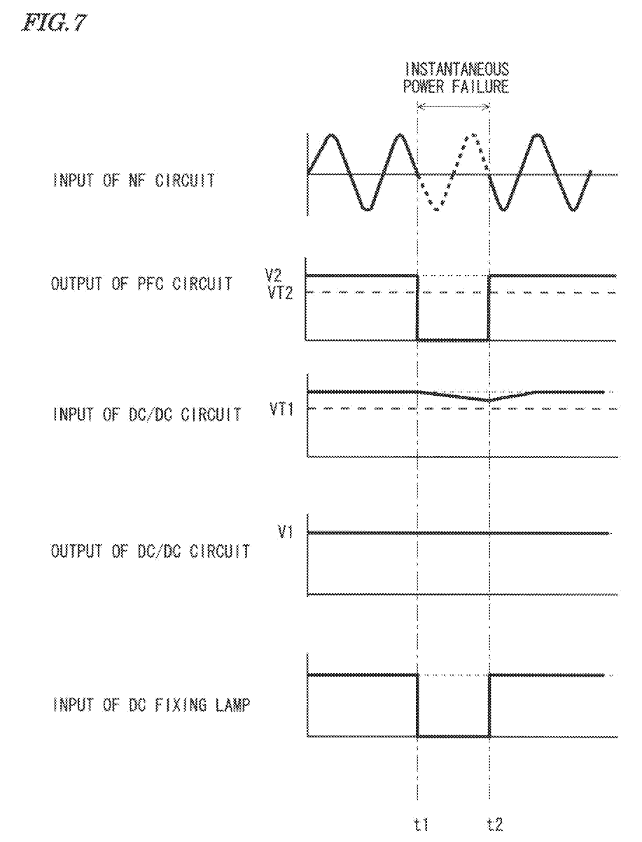

FIG. 7 is a diagram illustrating one example of a voltage in a circuit during an instantaneous power failure of the power supply device according to the first modification example. FIG. 7 illustrates, in order from the top, an input voltage of the NF circuit 51, an output voltage of the PFC circuit 55, an input voltage of the DC/DC circuit 211, an output voltage of the DC/DC circuit 211 and an input voltage of the DC fixing lamp 75. Note that the input voltage of the DC fixing lamp 75 is a voltage in a case in which the DC fixing lamp 75 is switched ON by the lamp drive circuit 77.

It illustrates an instantaneous power failure in which power is not instantaneously supplied to a commercial power supply 200 for 20 ms from a point t1 to a point t2 in time. During the instantaneous power failure, power is not supplied to the input voltage of the NF circuit 51 from the commercial power supply 200.

At the point t1 in time, because the NF circuit 51 does not receive AC from the commercial power supply 200, the output voltage of the PFC circuit 55 drops to become equal to or smaller than the threshold value VT2. In response to this, because the switch 63 is opened at the point t1 in time, the input voltage of the DC fixing lamp 75 reaches zero.

At the point t2 in time, when the NF circuit 51 receives AC from the commercial power supply 200, the output voltage of the PFC circuit 55 increases to become larger than the threshold value VT2. In response to this, because the switch 63 is closed at the point t2 in time, the input voltage of the DC fixing lamp 75 reaches a voltage for normal use.

The lamp drive circuit 77 is a relay circuit for switching ON and OFF of a switch of the DC fixing lamp 75 based on an output of a thyristor, and does not include a nonvolatile memory or a CPU. Therefore, even after a voltage supplied to the lamp drive circuit 77 drops to zero, the ON-OFF control for the DC fixing lamp 75 can be continued after a predetermined voltage is supplied.

With reference to FIG. 6, with the NF circuit 51 not receiving AC from the commercial power supply 200, the output voltage of the PFC circuit 55 drops. Thus, the capacitor 57 starts discharging, and a DC voltage is applied to the DC/DC circuit 211. Therefore, as illustrated in the third diagram from the top in FIG. 7, although gradually dropping, the input voltage of the DC/DC circuit 211 is maintained higher than a lower limit value VT1. The output voltage of the DC/DC circuit 211 is maintained at a constant value V1 also during the instantaneous power failure. Because the switch 63 is opened, the power supplied from the capacitor 57 is not supplied to the lamp drive circuit 77. Therefore, the capacitance of the capacitor 57 is defined based on the power consumption of the main circuit 110 of the first load 210, and a power failure period of time, with the power failure period of time being predetermined as the maximum period of time during which power is instantaneously not supplied to the commercial power supply 200. In other words, the capacitance of the capacitor 57 does not need to be defined in consideration of the power consumption of the second load 220.

### Second Modification Example

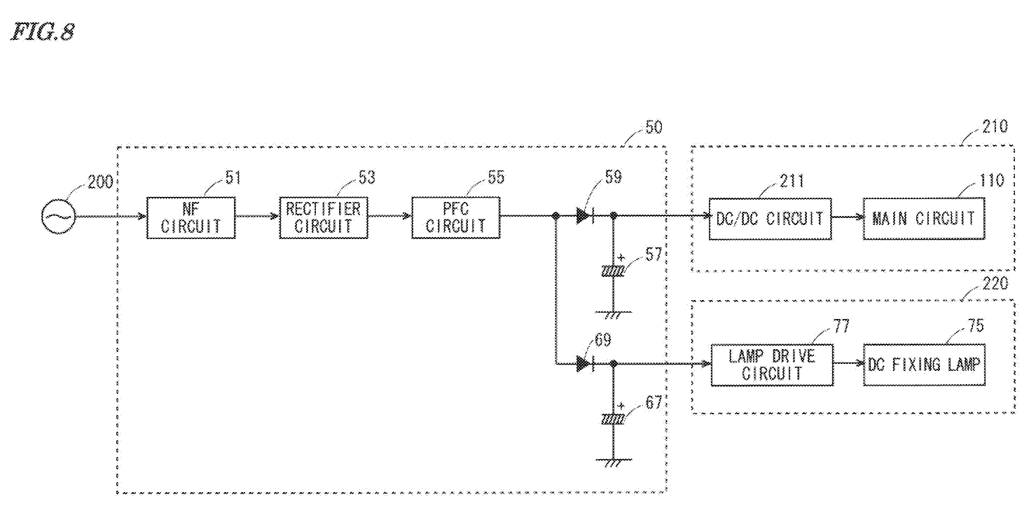

FIG. 8 is a diagram illustrating one example of the configuration of an internal circuit of a power supply device according to a second modification example. With reference to FIG. 8 the power supply device 50B in the second modification example is different from the above-mentioned power supply device 50 in that a lamp diode 69 and a lamp capacitor 67 are arranged between a PFC circuit 55 and a second load 220. The other configurations of the power supply device 50B in the second modification example are the same as those of the above-mentioned power supply device 50. Therefore, the detailed description thereof will not be repeated.

An output of the PFC circuit 55 is connected to respective anodes of a diode 59 and the lamp diode 69. A cathode of the lamp diode 69 is connected to a first load 210. One end of the lamp capacitor 67 is connected between the cathode of the lamp diode 69 and the second load 220. The other end of the lamp capacitor 67 is grounded. A capacitor 57, the first load 210, the lamp capacitor 67 and the second load 220 are connected in parallel to the PFC circuit 55.

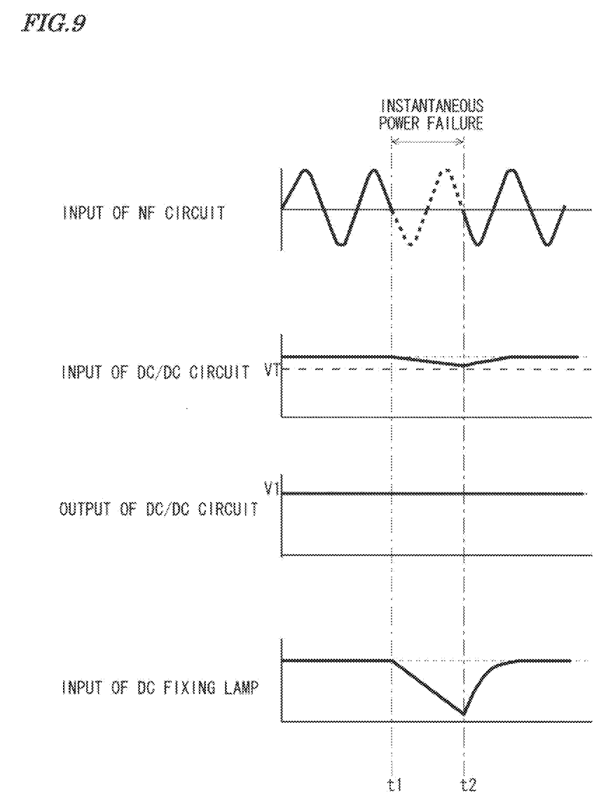

FIG. 9 is a diagram illustrating one example of a voltage in a circuit during an instantaneous power failure of the power supply device according to the second modification example. FIG. 9 illustrates, in order from the top, an input voltage of an NF circuit 51, an input voltage of a DC/DC circuit 211, an output voltage of the DC/DC circuit 211 and an input voltage of a DC fixing lamp 75. Note that the input voltage of the DC fixing lamp 75 is a voltage in a case in which the DC fixing lamp 75 is switched ON by a lamp drive circuit 77.

As compared with FIG. 4, the input voltage of the DC fixing lamp 75 illustrated in the fourth diagram from the top of FIG. 5 is different. With reference to FIGS. 8 and 9, at a point t1 in time, when the NF circuit 51 no longer receives AC from a commercial power supply 200, an output voltage of the PFC circuit 55 drops. Thus, the lamp capacitor 67 starts discharging, and a DC voltage is applied to the lamp drive circuit 77. Therefore, as illustrated in the fourth diagram from the top of FIG. 9, the input voltage of the DC fixing lamp 75 gradually drops. Because being interrupted by the lamp diode 69, power supplied from the lamp capacitor 67 is not supplied to the DC/DC circuit 211.

At a point t2 in time, when the NF circuit 51 receives AC from the commercial power supply 200, the output voltage of the PFC circuit 55 increases. Thus, the lamp capacitor 67 starts to store electric charge, and the DC voltage applied to the lamp drive circuit 77 increases. Therefore, as illustrated in the fourth diagram from the top of FIG. 9, the input voltage of the DC fixing lamp 75 gradually increases.

The capacitance of the lamp capacitor 67 can be defined based on the power consumption of the DC fixing lamp 75 and the maximum value for an instantaneous power failure period of time. The capacitance of the lamp capacitor 67 is preferably set to a capacity that enables, during an instantaneous power failure, maintenance of power equal to or larger than a voltage at which the lamp capacitor 67 is workable. In this case, the DC fixing lamp 75 can work normally during an instantaneous power failure. Because the lamp capacitor 67 is added, the product cost increases. However, the capacitance of the lamp capacitor 67 is smaller than the capacitance of the capacitor in a case in which one capacitor is used to supply power to the first load 210 and the second load 220. The larger the capacitance of a capacitor, the higher the price of a capacitor. Therefore, the product cost can be reduced in some cases.

As described above, the power supply device 50 in the present embodiment includes the NF circuit 51 to which any one of a plurality of commercial power supplies can be connected, the capacitor 57, the PFC circuit 55 and the diode 59 (switch section), with the diode 59 being arranged between first load 210 and capacitor 57, and the PFC circuit 55. The capacitor 57, the first load 210 and the second load 220 are connected in parallel to the PFC circuit 55. The PFC circuit 55 converts AC that is input to the NF circuit 51 into DC of a predetermined voltage, and outputs the DC to the capacitor 57, the first load 210 and the second load 220.

Because the first load 210, the second load 220 and the capacitor 57 are connected in parallel to the PFC circuit 55, power is supplied to the first load 210, the second load 220 and the capacitor 57 in a period during which power is output from the PFC circuit 55. Further, during an instantaneous power failure of the commercial power supply 200, the power supply device 50 is switched by the diode 59 to a state in which power is not supplied from the capacitor 57 to the second load 220 and power is supplied to the first load 210.

Therefore, because power is not supplied from the capacitor 57 to the second load 220, the capacitance of the capacitor 57 can be reduced, and the manufacturing cost can be suppressed.

The power supply device 50A in the first modification example includes the NF circuit 51 to which any one of a plurality of commercial power supplies can be connected, the capacitor 57, the PFC circuit 55, the switch 63 (switch section ) arranged between the PFC circuit 55 and the second load 220, and the controller 61 that controls the switch 63 based on presence or absence of an instantaneous power failure of the commercial power supply 200. The capacitor 57, the first load 210 and the second load 220 are connected in parallel to the PFC circuit 55. The PFC circuit 55 converts AC that is input to the NF circuit 51 into DC of a predetermined voltage, and outputs the DC to the capacitor 57, the first load 210 and the second load 220.

The switch 63 is arranged between the PFC circuit 55 and the second load 220, and the switch 63 is controlled by the controller 61 based on presence or absence of an instantaneous power failure of the commercial power supply 200. Therefore, by the control for opening the switch 63 during an instantaneous power failure of the commercial power supply 200, it is possible to supply power from the capacitor 57 to the first load 210 and to prevent power from the capacitor 57 from being shared with the second load 220.

Further, the PFC circuit 55 includes the detector that detects its output voltage, and the controller 61 compares a voltage value detected by the detector with the threshold value VT2. The threshold value VT2 is defined based on the maximum power consumption of the first load 210. Therefore, power required for the first load 210 can be supplied to the commercial power supply 200 during an instantaneous power failure of the commercial power supply 200.

Further, the MFP 100 further includes the DC/DC circuit 211 that converts a DC voltage that is output from the PFC circuit 55. The DC/DC circuit 211 may be included in the MFP 100 or in the power supply device 50. Therefore, even in a case in which the first load 210 includes a plurality of loads respectively driven at a plurality of voltages, it is possible to supply power to the plurality of respective loads.

Further, the first load 210 is the main circuit 110 including the CPU 111 and the RAM 114. The second load 220 does not include a volatile memory or a central processing unit. Therefore, the power supply device 50 can prevent the CPU 111 of the first load 210 from being stopped during an instantaneous power failure. Because the second load 220 does not include a volatile memory or a central processing unit, there is no problem with an operation even when an instantaneous power failure occurs.

The capacitance of the capacitor 57 is defined based on the power consumption of the first load 210 and a power failure period of time, with the power failure period of time being predetermined as a period of time during which the commercial power supply 200 instantaneously fails. Therefore, power can be supplied from the capacitor 57 to the first load 210 at least during the power failure period of time.

### Overview of Embodiment

(Item 1) A power supply device includes an AC input section to which any one of a plurality of commercial power supplies is connectable, a power storage, a power factor correction circuit that converts AC that is input to the AC input section into DC of a predetermined voltage, and outputs the DC to the power storage and an external first and an external second load that are connected in parallel, and a switch section that, during an instantaneous power failure of the commercial power supply connected to the AC input section, switches the power supply device to a state where power is supplied from the power storage to the first load and power is not supplied from the power storage to the second load.

According to this aspect, because the first load, the second load and the power storage are connected in parallel to the power factor correction circuit, power is supplied to the first load, the second load and the power storage in a period during which power is output from the power factor correction circuit. Further, during the instantaneous power failure of the commercial power supply, the power supply device is switched to a state in which power is not supplied from the power storage to the second load and power is supplied to the first load. Therefore, during the instantaneous power failure of the commercial power supply, power is supplied from the power storage to the first load, and power is not supplied to the second load. Therefore, because power is not supplied from the power storage to the second load, the capacitance can be reduced. As a result, it is possible to provide the power supply device with the reduced manufacturing cost.

(Item 2) The power supply device according to item 1, wherein the switch section includes a diode arranged between the first load and the power storage, and the power factor correction circuit, and the second load is connected between the power factor correction circuit and the diode.

According to this aspect, the diode is arranged between the first load and the power storage, and the power factor correction circuit, and the second load is connected between the power factor correction circuit and the diode. Therefore, in a period during which power is not output from the power factor correction circuit, power is supplied from the power storage to the first load, and power is not shared by the power storage with the second load.

(Item 3) The power supply device according to item 1, wherein the switch section includes a switch arranged between the power factor correction circuit and the second load, and a controller that controls the switch based on presence or absence of an instantaneous power failure of the commercial power supply.

According to this aspect, the switch is arranged between the power factor correction circuit and the second load, and the switch is controlled based on presence or absence of an instantaneous power failure of the commercial power supply.

According to this aspect, by the control for opening the switch during an instantaneous power failure of the commercial power supply, power can be supplied from the power storage to the first load, and power can be prevented from being shared by the power storage with the second load.

(Item 4) The power supply device according to item 3, further includes a detector that detects a voltage value of DC that is output from the power factor correction circuit, wherein the controller compares the voltage value detected by the detector with a threshold value that is defined based on maximum power consumption of the first load.

According to this aspect, the threshold value with which the voltage value of the DC output from the power factor correction circuit is compared is defined based on the maximum power consumption of the first load. Therefore, the power required for the first load can be supplied to the first load during an instantaneous power failure of the commercial power supply.

(Item 5) The power supply device according to any one of items 1 to 4, further includes a voltage transformer circuit that converts a voltage of DC that is output from the power factor correction circuit.

According to this aspect, because the voltage transformer circuit is included, power can be supplied to a plurality of loads respectively driven at a plurality of voltages.

(Item 6) The power supply device according to any one of items 1 to 5, wherein the first load includes a volatile memory and a central processing unit, and the second load does not include a volatile memory or a central processing unit.

According to this aspect, because the first load includes the volatile memory and the central processing unit, the central processing unit can be prevented from being stopped. Because the second load does not include a volatile memory or a central processing unit, there is no problem with an operation even when an instantaneous power failure occurs.

(Item 7) The power supply device according to any one of items 1 to 6, wherein capacitance of the power storage is defined based on power consumption of the first load and a power failure period of time that is predetermined as a period of time during which AC is no longer output from the AC input section.

According to this aspect, power can be supplied from the power storage to the first load at least during a power failure.

(Item 8) An image processing apparatus according to any one of items 1 to 7 includes the power supply device, the first load and the second load.

According to this aspect, it is possible to provide the image processing apparatus with the reduced manufacturing cost.

It should be understood that the embodiments disclosed herein are illustrative and non-restrictive in all respects. The scope of the present invention is defined not by the above description but by the appended claims, and is intended to include any modifications within the scope and meaning equivalent to the appended claims.

Although embodiments of the present invention have been described and illustrated in detail, the disclosed embodiments are made for purpose of illustration and example only and not limitation. The scope of the present invention should be interpreted by terms of the appended claims.

What is claimed is:

1. A power supply device comprising:
an AC input section to which any one of a plurality of commercial power supplies is connectable;
a power storage;
a power factor correction circuit that converts AC that is input to the AC input section into DC of a predetermined voltage, and outputs the DC to the power storage and an external first and an external second load that are connected in parallel; and
a switch section that, during an instantaneous power failure of the commercial power supply connected to the AC input section, switches the power supply device to a state where power is supplied from the power storage to the first load and power is not supplied from the power storage to the second load.

2. The power supply device according to claim 1, wherein
the switch section includes a diode arranged between the first load and the power storage, and the power factor correction circuit, and
the second load is connected between the power factor correction circuit and the diode.

3. The power supply device according to claim 1, wherein
the switch section includes
a switch arranged between the power factor correction circuit and the second load, and
a controller that controls the switch based on presence or absence of an instantaneous power failure of the commercial power supply.

4. The power supply device according to claim 3, further comprising a detector that detects a voltage value of DC that is output from the power factor correction circuit, wherein
the controller compares the voltage value detected by the detector with a threshold value that is defined based on maximum power consumption of the first load.

5. The power supply device according to claim 1, further comprising a voltage transformer circuit that converts a voltage of DC that is output from the power factor correction circuit.

6. The power supply device according to claim 1, wherein
the first load includes a volatile memory and a central processing unit, and
the second load does not include a volatile memory or a central processing unit.

7. The power supply device according to claim 1, wherein
capacitance of the power storage is defined based on power consumption of the first load, and a power failure period of time that is predetermined as a period of time during which AC is no longer output from the AC input section.

8. An image processing apparatus comprising the power supply device, the first load and the second load according to claim 1.
